(19) United States
(12) Patent Application Publication
(10) Pub. No.: US 2006/0018365 A1
(43) Pub. Date: Jan. 26, 2006

(54) Method for transmitting a signal using a precise adaptive modulation and coding scheme in a frequency hopping-orthogonal frequency division multiple access communication system

(75) Inventors: Young-Ho Jung, Yongin-si (KR); Chan-Soo Hwang, Yongin-si (KR); Yong-Hoon Lee, Yuseong-gu (KR); Kyung-Min Kim, Yuseong-gu (KR); Jae-Yeun Yun, Bucheon-si (KR); Won-Yong Shin, Yongin-si (KR); Jin-Gon Joung, Seoul (KR); Woo-Hyuk Chang, Gyeongsan-si (KR); Woo-Seok Nam, Yeonje-gu (KR)

Correspondence Address: DILWORTH & BARRESE, LLP, 333 EARLE OVINGTON BLVD., UNIONDALE, NY, 11553, US

(73) Assignees: SAMSUNG ELECTRONICS CO., LTD., Suwon-si (KR); Korea Advanced Institute of Science and Technology (KAIST), Yusong-gu (KR)

(21) Appl. No.: 11/188,056

(22) Filed: Jul. 22, 2005

(30) Foreign Application Priority Data
Jul. 22, 2004 (KR) 2004-60008

(51) Int. Cl. H04B 1/713

(52) U.S. Cl. 375/132

(57) ABSTRACT

A method of transmitting a signal by using an Adaptive Modulation and Coding scheme in a Frequency Hopping-Orthogonal Frequency Division Multiplexing Access communication system capable of dividing total frequency bands into a plurality of sub-carrier bands and including a plurality of sub-channels, which are sets of predetermined sub-carrier bands, and a plurality of cells. The method includes the steps of allocating a predetermined number of sub-channels as AMC sub-channels per each cell matching with predetermined conditions in order to apply the AMC scheme to the AMC sub-channels, and allocating remaining sub-channels except for the AMC sub-channels as FH-OFDMA sub-channels in order to apply an FH-OFDMA scheme to the FH-OFDMA sub-channels.

### PRIORITY

This application claims priority to an application entitled “Method For Transmitting A Signal Using A Precise Adaptive Modulation And Coding Scheme In A Frequency Hopping-Orthogonal Frequency Division Multiplexing Access Communication System” filed with the Korean Intellectual Property Office on Jul. 22, 2004 and assigned Serial No. 2004-60008, the contents of which are incorporated herein by reference.

### BACKGROUND OF THE INVENTION

1. Field of the Invention

The present invention relates to a Frequency Hopping-Orthogonal Frequency Division Multiple Access (FH-OFDMA) communication system, and more particularly to a method for transmitting a signal using a precise adaptive modulation and coding (AMC) scheme in an FH-OFDMA communication system.

2. Description of the Related Art

Recently, various studies and research have been being carried out for 4^{th} generation (4G) communication systems in order to provide subscribers with services having superior quality of service (QoS) at a higher transmission speed, about 100 Mbps. In particular, studies are being actively carried out in relation to the 4G communication systems in order to provide subscribers with high speed services by ensuring mobility and QoS in wireless local area network (LAN) communication systems and wireless metropolitan area network (MAN) communication systems, which can provide services at a relatively high speed.

In order to support a broadband transmission network for a physical channel of a wireless MAN communication system, an orthogonal frequency division multiplexing (OFDM) scheme and an orthogonal frequency division multiple access (OFDMA) scheme are utilized. According to the OFDM/OFDMA schemes, a physical channel signal is transmitted by using a plurality of sub-carriers, so data can be transmitted at a high transmission rate. In addition, signals can be transmitted through different sub-carrier bands, so that a frequency diversity gain can be obtained.

According to the frequency hopping (FH) scheme, a frequency band of a transmission signal is hopped into the other frequency band according to a predetermined frequency hopping pattern in order to obtain an average gain of an inter cell interference (ICI). An FH-OFDMA scheme has been provided by combining the FH scheme with the OFDMA scheme. According to the FH-OFDMA scheme, a unique sub-channel is allocated to each user. That is, each mobile station (MS) and the sub-channel allocated to each MS is frequency-hopped according to a predetermined frequency hopping pattern, thereby obtaining a frequency diversity gain and an average gain of an inter cell interference. Herein, the sub-channel signifies a channel including at least one sub-carrier.

Hereinafter, a conventional FH-OFDMA communication system will be described with reference to FIG. 1, which illustrates the structure of the conventional FH-OFDMA communication system.

Referring to FIG. 1, the conventional FH-OFDMA communication system has a multi-cell structure including a cell 100 and a cell 150. The conventional FH-OFDMA communication system includes a base station (BS) 110 for managing the cell 100, a base station 140 for managing the cell 150, and a plurality of MSs 111, 113, 130, 151 and 153. The BSs 110 and 140 make communication with the MSs 111, 113, 130, 151 and 153 through the FH-OFDMA scheme.

Since the FH-OFDMA communication system has a multi-cell structure, it is necessary to use only a part of sub-channels for each cell of the FH-OFDMA communication system in order to obtain the average gain of ICI, that is, in order to minimize the ICI through the FH scheme. For this reason, the FH-OFDMA communication system may degrade a frequency reuse factor.

As mentioned above, the 4G mobile communication system has been suggested in order to provide users with high-speed and high-quality services. In general, the channel environment of the mobile communication system may frequently vary depending on AWGN (Additive White Gaussian Noise), power variation of a receiving signal caused by a fading phenomenon, shadowing, a Doppler effect caused by a movement and speed variation of the MS, and an interference caused by other MSs or multi-path signals.

For this reason, various schemes have been suggested in order to provide high-speed and high-quality services. One of them is an AMC scheme.

The AMC scheme is a data transmission scheme, in which a channel modulation scheme and a coding scheme are determined according to a channel state of a cell, that is, according to a channel state between the BS and MS, thereby improving cell utilization. The AMC scheme includes a plurality of modulation schemes and coding schemes and modulates or codes a channel signal by combining the modulation scheme with the coding scheme. In general, the combination of the modulation scheme and the coding scheme is referred to as a modulation and coding scheme (MCS) and a plurality of MCSs including level 1 to level N MCSs are defined according to the number of MCSs. That is, according to the AMC scheme, the level of the MCS is adaptively determined based on the channel state between the MS and the BS connected to the MS, thereby improving system efficiency of the BS.

If the AMC scheme is used in a single cell environment without using the FH scheme, the AMC scheme can improve a data transmission rate by allocating a sub-channel having a superior channel state to a corresponding MS by comparing channel states of the MSs. However, if the AMC scheme is used in a multi-cell environment using the FH scheme, the AMC scheme may represent a problem in relation to an inter cell interference.

Accordingly, it is necessary to provide an FH-OFDMA scheme capable of obtaining a frequency diversity gain and an average gain of an inter cell interference while improving the frequency reuse factor and the data transmission rate.

### SUMMARY OF THE INVENTION

Accordingly, the present invention has been made to solve the above-mentioned problems occurring in the prior art, and an object of the present invention is to provide a method for transmitting a signal capable of improving a data transmission rate in an FH-OFDMA communication system.

Another object of the present invention is to provide a method for transmitting a signal capable of improving a frequency reuse factor in an FH-OFDMA communication system.

Still another object of the present invention is to provide a method for transmitting a signal capable of improving a data transmission rate and a frequency reuse factor in an FH-OFDMA communication system.

Still another object of the present invention is to provide a method for transmitting a signal through an AMC scheme in an FH-OFDMA communication system.

In order to accomplish these objects, according to a first aspect of the present invention, there is provided a method of transmitting a signal by using an adaptive modulation and coding (AMC) scheme in an FH-OFDMA communication system capable of dividing total frequency bands into a plurality of sub-carrier bands and including a plurality of sub-channels, which are sets of predetermined sub-carrier bands, and a plurality of cells, the method including the steps of allocating a predetermined number of sub-channels as AMC sub-channels per each cell matching with predetermined conditions in order to apply the AMC scheme to the AMC sub-channels; and allocating remaining sub-channels, except for the AMC sub-channels, as FH-OFDMA sub-channels in order to apply an FH-OFDMA scheme to the FH-OFDMA sub-channels.

In order to accomplish these objects, according to a second aspect of the present invention, there is provided a method of transmitting a signal by using an adaptive modulation and coding (AMC) scheme in an FH-OFDMA communication system capable of dividing total frequency bands into a plurality of sub-carrier bands and including a plurality of sub-channels, which are sets of predetermined sub-carrier bands, and a plurality of cells, the method including the steps of allocating a predetermined number of sub-channels as AMC sub-channels per each cell matching with predetermined conditions in order to apply the AMC scheme to the AMC sub-channels; allocating remaining sub-channels except for the AMC sub-channels as FH-OFDMA sub-channels in order to apply an FH-OFDMA scheme to the FH-OFDMA sub-channels; determining a region having the AMC sub-channels as an AMC sub-cell; determining a region having the FH-OFDMA sub-channels as an FH-OFDMA sub-cell; and setting a cell loading factor of the AMC sub-cell differently from a cell loading factor of the FH-OFDMA sub-cell.

### BRIEF DESCRIPTION OF THE DRAWINGS

The above and other objects, features and advantages of the present invention will be more apparent from the following detailed description taken in conjunction with the accompanying drawings, in which:

FIG. 1 illustrates a structure of a conventional FH-OFDMA communication system;

FIG. 2 illustrates a structure of a concentric sub-cell depending on a characteristic of an MS according to an embodiment of the present invention;

FIG. 3 illustrates a usable frequency band according to a structure of a concentric sub-cell shown in FIG. 2;

FIG. 4 illustrates a structure of a concentric sub-cell employing a multi-cell loading factor according to an embodiment of the present invention;

FIG. 5 illustrates a structure of a concentric sub-cell when a multi-cell loading factor is employed according to an embodiment of the present invention;

FIG. 6 illustrates a co-channel interference relationship between AMC MSs of an AMC group shown in FIG. 5;

FIG. 7 illustrates structures of a home cell and a co-channel cell according to an embodiment of the present invention when a frequency reuse factor is 1/7;

FIG. 8 illustrates a usable frequency band of an AMC group shown in FIG. 5;

FIG. 9 illustrates a cell structure causing an interference to an FH-OFDMA group according to an embodiment of the present invention; and

FIG. 10 is an equation defining an average interference signal level when an AMC group is provided together with an FH-OFDMA group.

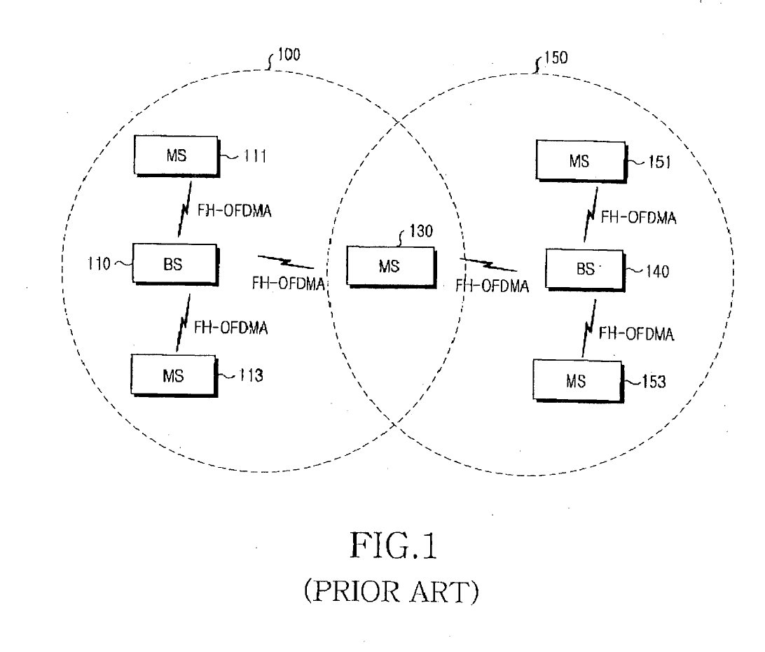

### DETAILED DESCRIPTION OF THE PREFERRED EMBODIMENT

Hereinafter, embodiments of the present invention will be described with reference to the accompanying drawings.

In the following detailed description, representative embodiments of the present invention will be described. In addition, a detailed description of known functions and configurations incorporated herein will be omitted when it may make the subject matter of the present invention unclear.

The present invention suggests a method for transmitting a signal using a precise adaptive modulation and coding (AMC) scheme in a Frequency Hopping-Orthogonal Frequency Division Multiple Access (FH-OFDMA) communication system.

In particular, the present invention suggests a structure of a concentric sub-cell according to the characteristics of a mobile station (MS) in an FH-OFDMA communication system having a multi-cell structure and suggests a method of maximizing a data transmission rate by transmitting a signal through an AMC scheme in accordance with the structure of the concentric sub-cell. In addition, the present invention suggests a method of maximizing the efficiency of resource utilization by transmitting a signal through the AMC scheme in accordance with the structure of the concentric sub-cell while multiplexing a cell loading factor.

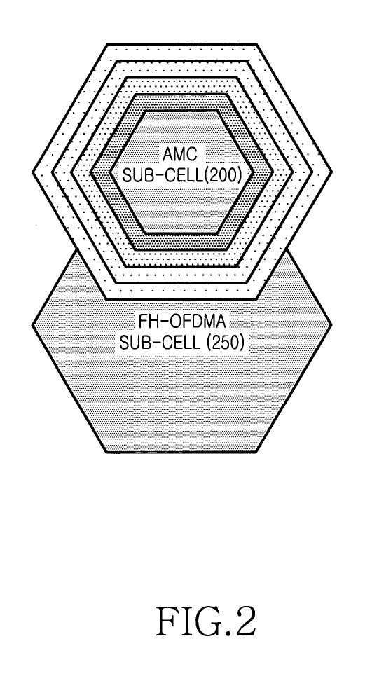

FIG. 2 illustrates a structure of a concentric sub-cell depending on a characteristic of an MS according to one embodiment of the present invention.

Two concentric sub-cells including an AMC sub-cell 200 and an FH-OFDMA sub-cell 250 are shown in FIG. 2. An AMC scheme and an FH-OFDMA scheme are applied to the AMC sub-cell 200 and the FH-OFDMA sub-cell 250 according to the characteristic of the MS, respectively, on the assumption that a base station (BS) exists at a center between the AMC sub-cell 200 and the FH-OFDMA sub-cell 250. The AMC sub-cell 200 and the FH-OFDMA sub-cell 250 can be obtained by logically dividing a cell region having the same physical characteristic according to the characteristic of a sub-band, that is, a characteristic of a sub-channel which is allocated to each MS matching with the characteristic of the MS. Herein, the sub-channel includes at least one sub-carrier.

The AMC sub-cell 200 has sub-channels allocated to MSs having relatively lower mobility (in particular, a static state) and a relatively higher signal to interference and noise ratio (SINR) and requiring a higher transmission rate. Herein, the MSs having the relatively lower mobility and higher SINR and requiring the high transmission rate are grouped as an AMC group. The MSs included in the AMC group are referred to as “AMC MSs”. Since the AMC MSs have a relatively stable channel state, the AMC MSs mainly exist at a cell center region. That is, as shown in FIG. 2, the MSs exist at the cell center region of the AMC sub-cell 200 with high density. For illustration purposes, the density of the AMC MSs is represented by the concentration of dots in FIG. 2.

In contrast, the FH-OFDMA sub-cell 250 has sub-channels allocated to MSs except for the MSs included in the AMC group. That is, the sub-channels of the FH-OFDMA sub-cell 250 are allocated to the MSs having relatively higher mobility and a relatively lower SINR and requiring a lower transmission rate. Herein, the MSs having the relatively higher mobility and lower SINR and requiring the lower transmission rate are grouped as an FH-OFDMA group. The MSs included in the FH-OFDMA group are referred to as “FH-OFDMA MSs”. Since the FH-OFDMA MSs have a relatively unstable channel state, the FH-OFDMA MSs mainly exist at a cell boundary region. That is, as shown in FIG. 2, the MSs exist at the cell boundary region of the FH-OFDMA sub-cell 250 with high density.

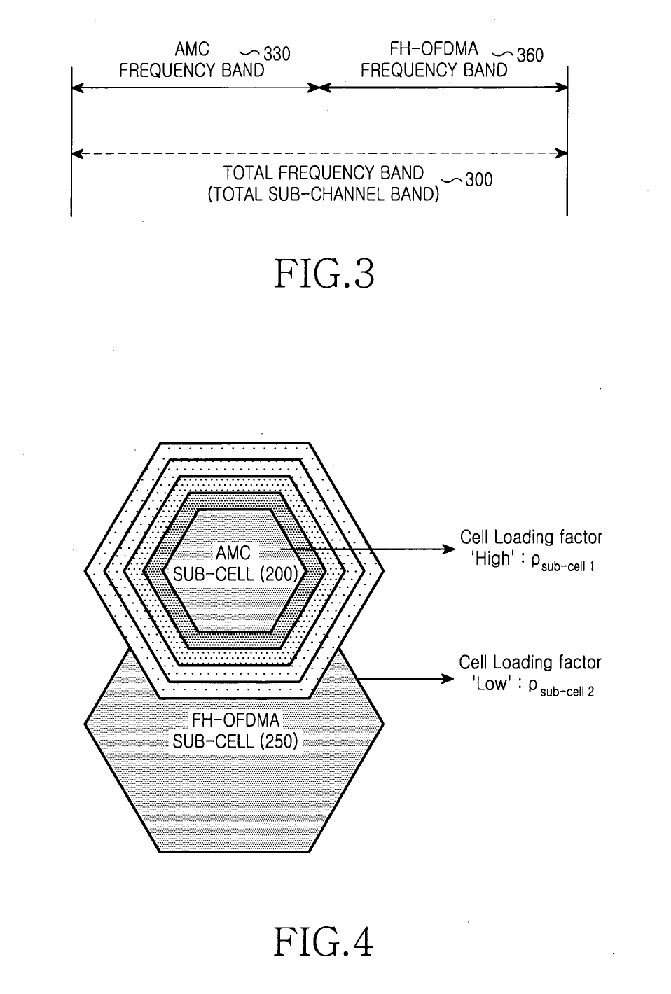

Hereinafter, a usable frequency band of the AMC sub-cell 200 and the FH-OFDMA sub-cell 250 will be described with reference to FIG. 3, which illustrates the usable frequency band according to a structure of the concentric sub-cell shown in FIG. 2.

Referring to FIG. 3, a total frequency band, that is, a total sub-channel band 300 is divided into an AMC frequency band 330 and an FH-OFDMA frequency band 360. The AMC frequency band 330 represents a frequency band for sub-channels allocated to the AMC MSs and the FH-OFDMA frequency band 360 represents a frequency band for sub-channels allocated to the FH-OFDMA MSs. A frequency reuse factor of the AMC frequency band 330 is set to less than ⅓ so as to minimize an inter cell interference. Herein, a ratio of the AMC frequency band 330 to the FH-OFDMA frequency band 360 in the total sub-channel band 300 may vary depending on system environment of the FH-OFDMA communication system. That is, a frequency band in the total sub-channel band 300 except for the AMC frequency band 330 is the FH-OFDMA frequency band 360.

Hereinafter, a method for applying cell loading factors to the AMC sub-cell 200 and the FH-OFDMA sub-cell 250 will be described with reference to FIG. 4. The cell loading factor signifies a ratio of sub-channels, which are used by a corresponding cell during a predetermined unit time interval, to the total sub-channels in the OFDM communication system. The predetermined unit time interval is an OFDM symbol interval.

FIG. 4 illustrates a structure of a concentric sub-cell employing a multi-cell loading factor according to one embodiment of the present invention.

Referring to FIG. 4, the cell loading factor applied to the AMC sub-cell 200 is different from the cell loading factor applied to the FH-OFDMA sub-cell 250. In a general FH-OFDMA communication system, the same cell loading factor is applied to each cell of the FH-OFDMA communication system over the whole frequency bands so as to perform frequency hopping per each MS. However, when taking multi-cell environment into consideration, an interference signal from a neighbor cell undergoes path loss according to a transmission distance thereof, so an influence of the interference signal upon the MSs may vary depending on the position of the MSs in the cell. Hereinafter, the influence of the interference signal of the neighbor cell according to the distance between the base station and the MS will be described.

Since the interference signal of the neighbor cell may exert less influence on the cell center region adjacent to the base station, the cell center region has a relatively higher SINR, so a resource having a higher frequency reuse factor is allocated to the corresponding MS. In contrast, since the interference signal of the neighbor cell may exert a great influence on the cell boundary region spaced at a relatively large distance from the base station, the cell boundary region has a relatively lower SINR, so a resource having a lower frequency reuse factor is allocated to the corresponding MS. That is, the frequency reuse factor applied to the MSs may vary corresponding to the SINR, thereby improving efficiency of resource utilization.

As described above with reference to FIG. 2, since the AMC sub-cell 200 has a large number of AMC MSs at the cell center region, the cell loading factor for the AMC sub-cell 200 must be determined by taking the characteristics of the cell center region into consideration. In other words, since the interference signal of the neighbor cell exerts the less influence on the AMC sub-cell 200, a higher frequency reuse factor, that is, a higher cell loading factor is applied to the AMC sub-cell 200. In contrast, since the FH-OFDMA sub-cell 250 has a large number of FH-OFDMA MSs at the cell boundary region, the cell loading factor for the FH-OFDMA sub-cell 250 must be determined by taking the characteristic of the cell boundary region into consideration. In other words, since the interference signal of the neighbor cell exerts the great influence on the FH-OFDMA sub-cell 250, a lower frequency reuse factor, that is, a lower cell loading factor is applied to the FH-OFDMA sub-cell 250, thereby improving efficiency of resource utilization.

In FIG. 4, the cell loading factor of the AMC sub-cell 200 is represented as “ρ_{sub-cell 1}”, and the cell loading factor of the FH-OFDMA sub-cell 250 is represented as “ρ_{sub-cell 2}”. A relationship between the cell loading factors of the AMC sub-cell 200 and the FH-OFDMA sub-cell 250 is represented in Equation 1.
ρ_{sub-cell 1}>ρ_{sub-cell 2} (1)

In addition, the number of sub-channels of the AMC sub-cell 200 and the FH-OFDMA sub-cell 250 for a unit time interval, that is, for an OFDMA symbol interval according to the above cell loading factors is represented in Equation 2.
N_{sub}·α·ρ_{sub-cell 1}+N_{sub}·(1−α)·ρ_{sub-cell 1}=N_{sub}·ρ_{cell} (2)

In Equation 2, N_{sub} is a number of sub-channels used in the FH-OFDMA communication system, a is a ratio of a frequency band of the AMC sub-cell 200 to total frequency bands of the FH-OFDMA communication system, and ρ_{cell} is a total cell loading factor. Accordingly, when the cell loading factors are applied to the AMC sub-cell 200 and the FH-OFDMA sub-cell 250, the total cell loading factor is represented as Equation 3.
ρ_{cell}=α·(ρ_{sub-cell 1}−ρ_{sub-cell 2}) +ρ_{sub-cell 2} (3)

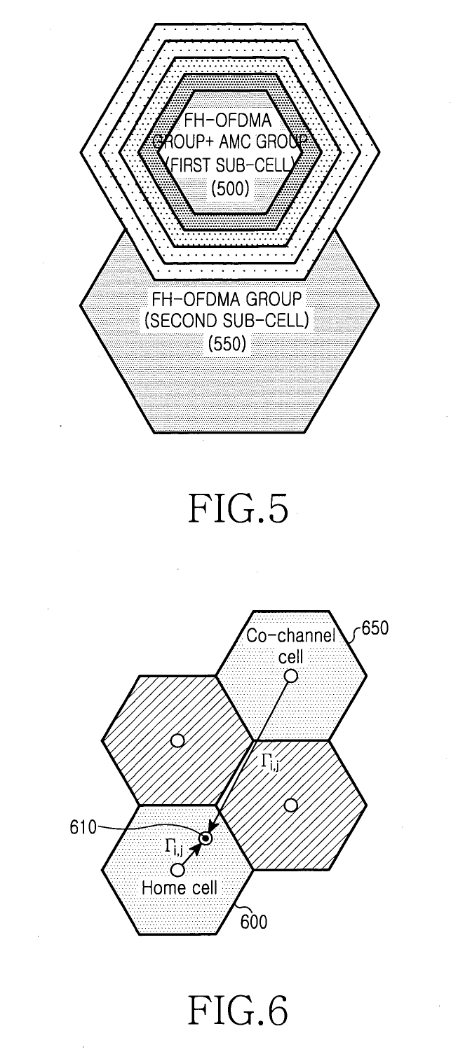

Hereinafter, a method of transmitting a signal at a high speed by using an AMC scheme in the FH-OFDMA communication system will be described with reference to FIG. 5.

FIG. 5 illustrates a structure of a concentric sub-cell when a multi-cell loading factor is employed according to one embodiment of the present invention.

Two concentric sub-cells including a first sub-cell 500 and a second sub-cell 550 are shown in FIG. 5. The cell loading factor applied to the first sub-cell 500 is different from the cell loading factor applied to the second sub-cell 550. The first sub-cell 500 has FH-OFDMA MSs included in the FH-OFDMA group and the second sub-cell 550 has FH-OFDMA MSs included in the FH-OFDMA group and AMC MSs included in the AMC group. If frequency bands of the sub-channels for the AMC MSs are allocated in the form of cell reuse frequency bands by taking co-channel interference (CCI) of the sub-channels to the neighbor cell into consideration, an average interference signal level of the AMC groups of each cell is represented as Equation 4.

$$\overline{{I}_{AMC} =} \frac{{P}_{tot}}{{N}_{sub} / {f}_{reuse}} \cdot {\sum }_{i = 1}^{{N}_{u}} {\sum }_{j = 2}^{{N}_{cell}} {ρ}_{i} \cdot {β}_{j} \cdot {Γ}_{i , j} \qquad ( 4 )$$

In Equation 4, Pₜₒₜ is total transmit power per each cell, N_{sub} is a number of total sub-carriers in the FH-OFDMA communication system, Γᵢⱼ is path loss between a j^{th} BS and an i^{th} MS, Nᵤ is a number of MSs per each cell, N_{cell} is a number of MSs in the FH-OFDMA communication system, ρᵢ is a number of sub-carriers allocated to an i^{th} MS, fᵣₑᵤₛₑ is a cell reuse factor, and βᵢ is defined in Equation 5.
βᵢ=1, i^{th} cell=co-channel cell
βᵢ=0, else (5)

In Equation 4, it is assumed that each cell includes only AMC groups and the same Pₜₒₜ and the same Nᵤ are applied to each cell.

Hereinafter, a CCI signal relationship between AMC MSs of an AMC group shown in FIG. 5 will be described with reference to FIG. 6.

FIG. 6 illustrates the CCI relationship between AMC MSs of the AMC group shown in FIG. 5.

Referring to FIG. 6, path loss Γᵢⱼ between a BS of a home cell 600 and an MS 610 is applied to the MS 610 of the home cell 600. That is, the CCI of a co-channel cell 650 acts as path loss Γᵢⱼ between the BS of the home cell 600 and the MS 610. The home cell signifies cells having the MS 610, and the co-channel cell signifies a cell applying the CCI to the cell having the MS 610.

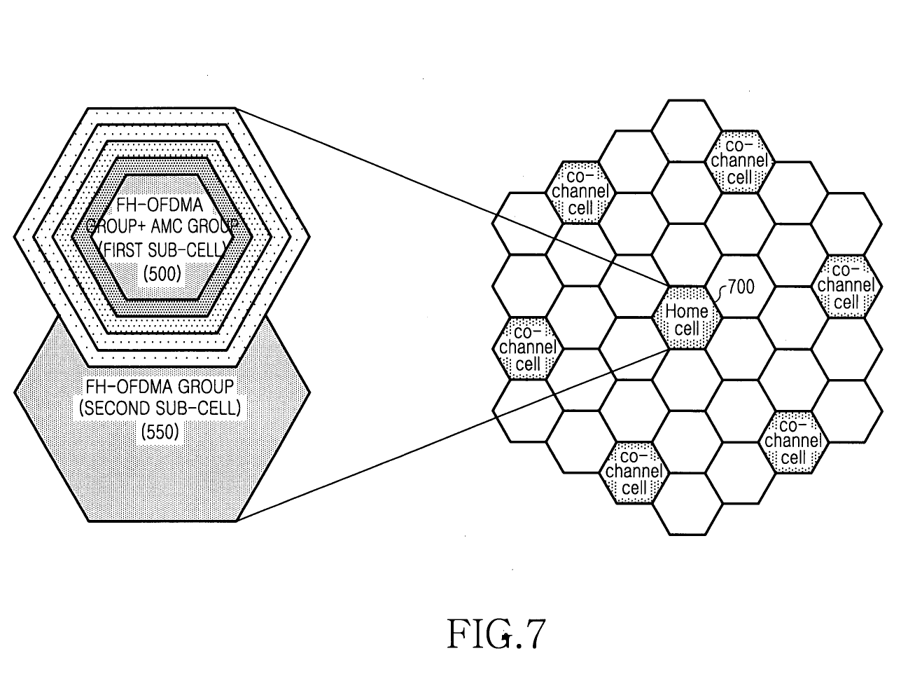

Hereinafter, co-channel cells applying the CCI to the AMC group of the home cell when a frequency reuse factor is 1/7 will be described with reference to FIG. 7.

FIG. 7 illustrates structures of the home cell and the co-channel cell according to one embodiment of the present invention when the frequency reuse factor is 1/7.

Referring to FIG. 7, since the frequency reuse factor is 1/7, neighbor cells, that is, co-channel cells applying the CCI to a home cell 700 are positioned at a 3^{rd} tier. Thus, the CCI of the co-channel cells is rarely applied to the home cell 700.

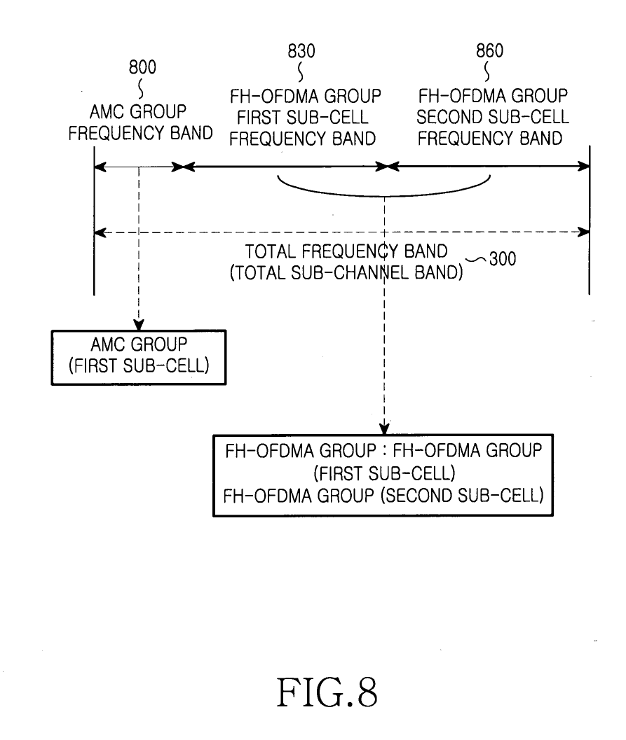

Hereinafter, a usable frequency band of an AMC group shown in FIG. 5 will be described with reference to FIG. 8.

FIG. 8 illustrates a usable frequency band of an AMC group shown in FIG. 5.

Referring to FIG. 8, a total frequency band, that is, a total sub-channel band 300 is divided into an AMC group frequency band 800, an FH-OFDMA group first sub-cell frequency band 830, and an FH-OFDMA group second sub-cell frequency band 860. The AMC group frequency band 800 represents a frequency band of sub-channels allocated to the AMC MSs of the AMC group of the first sub-cell 500, the FH-OFDMA group first sub-cell frequency band 830 represents a frequency band of sub-channels allocated to the FH-OFDMA MSs of the first sub-cell 500, and the FH-OFDMA group second sub-cell frequency band 860 represents a frequency band of sub-channels allocated to the FH-OFDMA MSs of the second sub-cell 550.

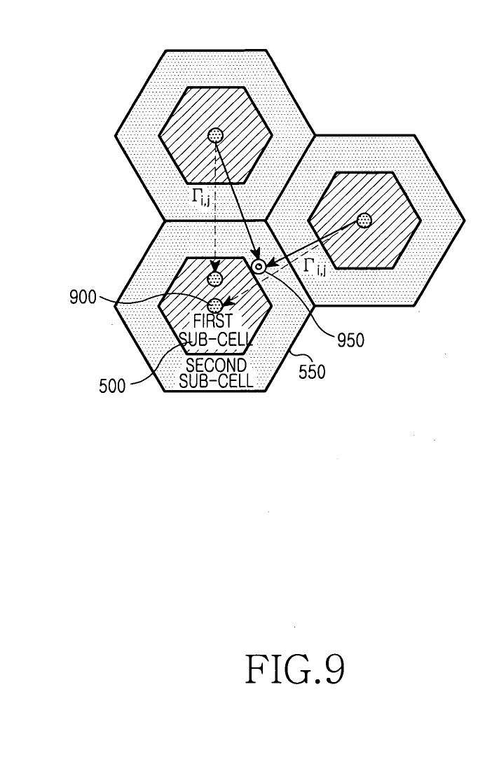

Hereinafter, cells causing the interference to the FH-OFDMA group will be described with reference to FIG. 9.

FIG. 9 illustrates a cell structure causing the interference to an FH-OFDMA group according to one embodiment of the present invention.

Prior to explaining FIG. 9, it is noted that the first sub-cell 500 and the second sub-cell 550 shown in FIG. 9 have shapes substantially identical to those of first and second sub-cells shown in FIG. 5 although the first sub-cell 500 and the second sub-cell 550 are shown in FIG. 9 as if they are different from first and second sub-cells shown in FIG. 5 for illustration purposes.

Referring to FIG. 9, since all cells have the same concentric sub-cell structure, only signals from sub-cells existing at cell center regions of neighbor cells act as interference signals for an MS 900 of the first sub-cell 500. Accordingly, the MS 900 of the first sub-cell 500 is subject to a relatively low interference signal, so it is possible to obtain the frequency hopping effect even if the cell loading factor is set to a high level.

In contrast, signals from sub-cells existing at cell boundary regions and cell center regions of neighbor cells act as interference signals for an MS 950 of the second sub-cell 550. Accordingly, the MS 950 of the second sub-cell 550 is subject to a relatively high interference signal, so it is necessary to set the cell loading factor to a low level in order to obtain frequency hopping effect.

An average interference signal level of each FH-OFDMA group is represented as Equation 6.

$$\overline{{I}_{FH} =} \frac{{P}_{tot}}{{N}_{sub}} \cdot \{ ξ \cdot {\sum }_{i = 1}^{{N}_{u - subcell1}} {\sum }_{j = 2}^{{N}_{cell}} {ρ}_{i} \cdot {Γ}_{i , j} + ( 1 - ξ ) {\sum }_{i = 1}^{{N}_{u - subcell2}} {\sum }_{j = 2}^{{N}_{cell}} {ρ}_{i} \cdot {Γ}_{i , j} \} \qquad ( 6 )$$

In Equation 6, N_{u-subcell1 (or subcell2)} is a number of MSs in each sub-cell, that is, a number of MSs in the first sub-cell 500 or in the second sub-cell 550, and ξ is the transmit power of the first sub-cell 500. Equation 6 is based on the assumption that each cell includes only FH-OFDMA groups under a perfect power control state, and the same transmit power and the same number of MSs are applied to each sub-cell.

Hereinafter, an operation of the FH-OFDMA communication system when the AMC group is provided together with the FH-OFDMA group will be described.

First, as described above with reference to FIG. 7, a predetermined sub-channel set is primarily allocated for the AMC group while applying the frequency reuse factor to each cell. Herein, when taking the ratio of the AMC MSs of the AMC group to the total MSs of the cells and an inter cell interference into consideration, the frequency reuse factor of the cell is preferably set to 1/7. If the frequency reuse factor of the cell is larger than 1/7, the number of sub-channels allocated to the AMC MSs of the AMC group may increase, so the number of sub-channels allocated to the MSs of the FH-OFDMA group may decrease. For this reason, the frequency hopping effect of the FH-OFDMA communication system may be decreased. In addition, since the position of the co-channel cells for the AMC MSs of the AMC group is adjacent to the home cell, the inter channel interference may increase.

In addition, a minimum transmit power satisfying QoS required for the FH-OFDMA MSs of the FH-OFDMA group is allocated to the FH-OFDMA MSs of the FH-OFDMA group, and remaining transmit power is allocated to the AMC MSs of the AMC group, thereby increasing total cell capacity.

In contrast, as described above with reference to FIG. 9, sub-channels except for the sub-channel set allocated to the AMC group are allocated to the FH-OFDMA group per each cell while applying the frequency reuse factor of 1 to each cell, thereby discriminating the FH-OFDMA groups according to sub-cells.

As described above, when the AMC group is provided together with the FH-OFDMA group, ICI types exerting an influence upon the cell capacity are classified as follows.
(1) AMC group
\textcircled{3} interference signal caused by AMC group of co-channel cell
\textcircled{2} interference signal caused by FH-OFDMA group of other cells
(2) FH-OFDMA group
\textcircled{1} interference signal caused by FH-OFDMA group of co-channel cell
\textcircled{2} interference signal caused by AMC group of other cells
\textcircled{3} interference signal caused by FH-OFDMA group of other cells

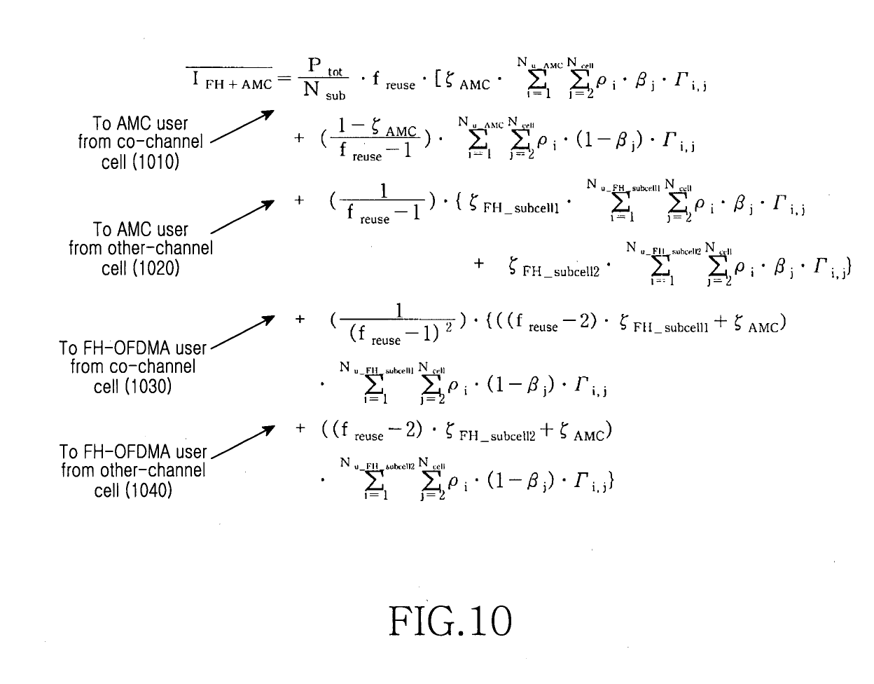

An average interference signal of inter cell interference signals is represented in FIG. 10.

FIG. 10 is an equation defining the average interference signal level when the AMC group is provided together with the FH-OFDMA group.

As shown in FIG. 10, when the AMC group is provided together with the FH-OFDMA group, the average interference signal level includes an interference signal 1010 caused by the AMC group of the co-channel cell, an interference signal 1020 caused by the AMC group of other cells, an interference signal 1030 caused by the FH-OFDMA group of co-channel cell, and an interference signal 1040 caused by the FH-OFDMA group of other cells.

Hereinafter, performance of the FH-OFDMA communication system employing the AMC scheme according to the present invention will be described as compared with performance of the conventional FH-OFDMA communication system with reference to Table 1.

TABLE 1

| | FH-OFDMA | FH-OFDMA + AMC | | |
|---|---|---|---|---|
| | MSs Only | FH-OFDMA | AMC MSs | |
| | (64 sub- | MSs (48 sub- | (16 sub- | |
| | carriers) | carriers) | carriers) | Total |
| Total trans- | 124 | 94 | 118.52 | 212.52 |
| mission | | | | |
| rate (bits/ | | | | |
| symbol) | | | | |
| Average | 1.9375 | 1.9583 | 7.408 | 3.32 |
| transmission | | | | |
| rate per sub- | | | | |
| carrier | | | | |
| (bits/symbol) | | | | |

In Table 1, the capacity of the FH-OFDMA communication system employing the AMC scheme according to the present invention is compared with capacity of the conventional FH-OFDMA communication system in order to compare performance of the above two systems. The performance comparison is based on transmission data bits per each OFDM symbol and transmission data bits per each sub-carrier under the state that the total transmission rate and the target BER (Bit Error Rate) are satisfied. Herein, sub-channels corresponding to about a half of total sub-channels are used under the same frequency efficiency in order to precisely compare performance of the above two systems.

It is assumed that the following scenario is applied to the FH-OFDMA communication system employing the AMC scheme according to the present invention.

The frequency reuse factor per each cell is set to 1/7 and a predetermined sub-channel set is primarily allocated for the AMC MSs of the AMC group. In addition, sub-channels except for the sub-channel set allocated to the AMC group are allocated to the FH-OFDMA MSs of the FH-OFDMA group while applying the frequency reuse factor of 1 to each sub-channel. Then, active sub-carriers are allocated to active users in the cell. That is, active sub-carriers are allocated to MSs, which are currently communicating with the BS in such a manner that the ratio of the active sub-carriers to the total sub-carriers is about ½ (50%).

It is also assumed that the following scenario is applied to the conventional FH-OFDMA communication system.

Each cell uses about a half of total sub-channels while setting the frequency reuse factor of 1 to each sub-channel and the sub-channels are allocated through a frequency hopping scheme. In addition, a perfect power control state is assumed in order to obtain an effect of a rough AMC scheme by taking large scale fading into consideration.

In addition, a simulation test environment for evaluating performance of the above two systems is assumed as a multi-cell structure having 37 cells including a home cell positioned at a 3^{rd} tier, in which all cells, that is, neighbor cells except for the home cell may generate only interference signals. In addition, it is assumed that each of the 37 cells has the same cell loading factor, the number of the MSs of the home cell is 9, and capacity per single cell is compared under the state that total transmission power and target BER conditions are satisfied.

The main parameters for evaluating performance of the above two systems are as follows:
(1) Total sub-carriers=128
(2) Number of sub-carriers used for the conventional FH-OFDMA communication system=64 (50% loading), all of which are allocated to FH-OFDMA MSs of the FH-OFDMA group
(3) Number of sub-carriers used for the FH-OFDMA communication system employing the AMC scheme according to the present invention=16 (FH-OFDMA) +48 (AMC), in which 48 sub-carriers are allocated to the AMC MSs of the AMC group and 16 sub-carriers are allocated to FH-OFDMA MSs of the FH-OFDMA group
(4) Power allocation=8 (FH-OFDMA MSs): 2 (AMC MSs)
(5) Number of AMC MSs=4
(6) Power control for FH-OFDMA MSs of FH-OFDMA group=perfect power control
(7) Modulation scheme=QPSK (Quadrature Phase Shift Keying) and 16/64/256 QAM (Quadrature Amplitude Modulation)
(8) Channel coding=No channel coding
(9) Channel estimation: MSE (Mean Square Error)=0.0158:0.0158
(10) Target BER=10⁻²
(11) Total cell transmit power=15 [dB]
(12) Path loss exponent=4

As can be understood from Table 1, the cell capacity of the FH-OFDMA communication system employing the AMC scheme according to the present invention is larger than cell capacity of the conventional FH-OFDMA communication system. If the FH-OFDMA communication system employs the AMC scheme, the FH-OFDMA communication system can transmit data at a relatively high transmission rate with a relatively low transmit power, so the FH-OFDMA communication system employing the AMC scheme according to the present invention represents cell capacity larger than that of the conventional FH-OFDMA communication system.

As described above, the FH-OFDMA communication system according to the present invention employs the AMC scheme and the frequency hopping scheme matching with characteristics of the MSs, thereby obtaining the frequency diversity gain and the average gain of the inter cell interference while improving the frequency reuse factor and transmission rate.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A method of transmitting a signal by using an Adaptive Modulation and Coding (AMC) scheme in a Frequency Hopping-Orthogonal Frequency Division Multiple Access (FH-OFDMA) communication system capable of dividing total frequency bands into a plurality of sub-carrier bands and including a plurality of sub-channels, which are sets of predetermined sub-carrier bands, and a plurality of cells, the method comprising the steps of:
allocating a predetermined number of sub-channels as AMC sub-channels per each cell matching with predetermined conditions in order to apply the AMC scheme to the AMC sub-channels; and
allocating remaining sub-channels, except for the AMC sub-channels, as FH-OFDMA sub-channels in order to apply an FH-OFDMA scheme to the FH-OFDMA sub-channels.

2. The method as claimed in claim 1, wherein the predetermined conditions include low mobility, a high transmission rate, and a high Signal to Interference and Noise Ratio (SINR).

3. The method as claimed in claim 1, wherein, if it is detected that a signal has to be transmitted to a predetermined Mobile Station (MS) after allocating the AMC sub-channels and the FH-OFDMA sub-channels, the signal is transmitted to the predetermined MS in accordance with the predetermined conditions of the predetermined MS by using the AMC sub-channels or the FH-OFDMA sub-channels.

4. A method of transmitting a signal by using an Adaptive Modulation and Coding (AMC) scheme in a Frequency Hopping-Orthogonal Frequency Division Multiple Access (FH-OFDMA) communication system capable of dividing total frequency bands into a plurality of sub-carrier bands and including a plurality of sub-channels, which are sets of predetermined sub-carrier bands, and a plurality of cells, the method comprising the steps of:
allocating a predetermined number of sub-channels as AMC sub-channels per each cell matching with predetermined conditions in order to apply the AMC scheme to the AMC sub-channels;
allocating remaining sub-channels except for the AMC sub-channels, as FH-OFDMA sub-channels, in order to apply an FH-OFDMA scheme to the FH-OFDMA sub-channels;
determining a region having the AMC sub-channels as an AMC sub-cell;
determining a region having the FH-OFDMA sub-channels as an FH-OFDMA sub-cell; and
setting a cell loading factor of the AMC sub-cell that is different from a cell loading factor of the FH-OFDMA sub-cell.

5. The method as claimed in claim 4, wherein the cell loading factor is a ratio of sub-channels, which are used by a corresponding cell during a predetermined time interval, to total sub-channels.

6. The method as claimed in claim 5, wherein the cell loading factor of the AMC sub-cells is higher than that of the FH-OFDMA sub-cells.

7. The method as claimed in claim 4, wherein the AMC sub-cells and the FH-OFDMA sub-cells are concentric sub-cells.

8. The method as claimed in claim 4, wherein the predetermined conditions include low mobility, a high transmission rate, and a high Signal to Interference and Noise Ratio (SINR).

9. The method as claimed in claim 4, wherein, if it is detected that a signal has to be transmitted to a predetermined Mobile Station (MS) after allocating the AMC sub-channels and the FH-OFDMA sub-channels, the signal is transmitted to the predetermined MS in accordance with the predetermined conditions of the predetermined MS by using the AMC sub-channels or the FH-OFDMA sub-channels.
